(19) United States
(12) Patent Application Publication
(10) Pub. No.: US 2023/0279928 A1
(43) Pub. Date: Sep. 7, 2023

(54) SINGLE CONTINUA DIFFERENTIAL PULLEY TRANSMISSION

(71) Applicant: Mechanomy LLC, Madison, WI (US)

(72) Inventor: Benjamin CONRAD, Madison, WI (US)

(73) Assignee: Mechanomy LLC, Madison, WI (US)

(21) Appl. No.: 18/176,637

(22) Filed: Mar. 1, 2023

Related U.S. Application Data
(60) Provisional application No. 63/315,887, filed on Mar. 2, 2022.

(51) Int. Cl. F16H 19/06

(52) U.S. Cl. CPC F16H 19/06; F16H 2019/0686

(57) ABSTRACT

A transmission converting rotational to translational movement for linear motion applications is provided. Several pulleys direct a single closed flexible continuous element to engage with two coupled pulleys on a moving element, forming a transmission which may realize large transmission ratios.

### CROSS REFERENCE TO RELATED APPLICATIONS

This application claims the benefit of priority to U.S. Provisional Patent Application No. 63/315,887 filed Mar. 2, 2022, which is hereby incorporated by reference, in its entirety for any and all purposes.

### BACKGROUND

This disclosure teaches three approaches to implementing differential mechanisms in rotary to translatory transmissions, most commonly effecting linear actuation. When realized in belt and cable systems, differential mechanisms of the form described can generate large transmission ratios at significantly less expense and less overall system complexity than traditional rotary transmission technologies. After considering relevant prior art, this disclosure presents three prototypical embodiments and associated design considerations.

To begin, consider the common task of converting rotary to translatory motion in which a cable or belt is made to circuit around driving and driven return pulleys, these being separated by some distance. The driving pulley is actuated by some torque source, commonly an electric motor. Between the driving and driven return pulleys a mobile element or carriage is affixed to a portion of the cable or belt such that the carriage moves with the cable or belt. The carriage is often constrained by a linear guide to move along the same path as the cable or belt. In this configuration, the movement of the carriage is substantially dependent on the rotation of the torque source plus any deleterious stretching or other nonlinearity of the cable or belt. Static or dynamic loads attached to the carriage are borne by the linear guide in directions transverse to the direction of motion, with the cable or belt transmitting loadings along the direction of motion to the fixed torque source.

Transmissions are commonly interposed between the torque source and the carriage to reduce the required performance of the torque source, often trading rotational and translational speeds for increased torque and force, respectively. Thus the overall positioning accuracy of and force delivered to a load attached to the carriage is determined by the properties of the torque source and transmission.

The majority of these transmissions take the form of a gear reduction between the torque source and driving pulley, though some employ a clever arrangement of one or more continuous elements and various pulleys to fashion a transmission substantially without gearing.

U.S. Pat. No. 2,309,578 to Drachman describes a differential chain mechanism to elevate an X-ray imager via a hand-crank. As the sprockets on the carriage in Drachman are coaxial, they are evenly displaced from the plane of rotation of the upper and lower sprockets, necessitating an out-of-plane movement for the nominally planar chain. This out-of-plane movement and resulting wear may be acceptable in this manually-operated application but if applied in quickly-moving automated applications will result in greater wear and unacceptably early failure.

More recently, U.S. Pat. No. 5,749,800 to Nagel utilizes two timing belts having different tooth pitches to avoid out-of-plane movement in a generic transmission for rotational or translational motion. Several belt routings are presented, utilizing either two single-sided timing belts or one dual-sided belt to increase design flexibility. The two-belt approach and associated pulleys adds a number of elements that serve to increase system complexity and cost relative to the present disclosure. The double-sided, differently-pitched belt approach is convenient to the application, but these belts are quite rare and challenging to procure. Also described is an embodiment where the transmission ratio is developed through gearing, a conventional approach made novel only by association to the preceding embodiments.

U.S. Pat. No. 5,830,094 to DeNijs is similar to Nagel in variously using two timing belts, a single belt and gearing, or a secondary belt system to form the differential mechanism. Their addition is to describe a clutch or belt clamp which permits the transmission ratio to be modified during operation, switching between the large transmission ratio of the differential and a unitary ratio when the belt is clamped to the carriage. This bimodal operation is relevant only to specific applications which plausibly benefit from the additional complexity of the second timing belt, pulleys, and clamp or clutch.

U.S. Pat. No. 6,134,978 to Lin describes a transmission mechanism for a scanner wherein a cable is routed among several pulleys causing a scanner head to move at a fraction of the velocity of the cable. Relative to the present invention is the use of a single cable routed to engage two pulleys of differing radii, these indirectly coupled by gearing or a secondary belt system. Although Lin does not contemplate use of other flexible elements, like belts, any implementation would exhibit approximately half the carriage stiffness of the present invention due to the long free segments between the driving and idle pulleys.

Finally, U.S. Pat. App. Pub. No. 2007/0219031 to Jones describes a series of compact cable actuators whose transmissions utilize timing belts. Jones describes a variant where the rotation axes of left and right idler pulleys are angled away from the stacked, coupled differential pulleys that are rotatably fixed to the mobile element. Angling the left and right axes away from the differential axis permits a single timing belt to travel from the plane of the first coupled pulley to that of the second, thereby compactly forming the differential transmission. As the single-sided timing belt is routed such that the teeth positively engage with only the coupled differential pulleys, that is all other pulleys contact the flat side of the belt, the torque source is required to attach to the carriage to drive coupled pulleys. As the actuator's load is also attached to the moving carriage, this requirement reduces the maximum load by that of the torque source's mass. The moving torque source requires flexible power delivery and control apparatus, a non-trivial challenge and likely point of first failure.

The limitations of the prior approaches—the out-of-plane chain movement and wear, use of multiple belts, use of cables, or requirement of a moving torque source—have substantially reduced the use of differential pulley transmissions in converting rotary to translatory motion, leading to the use of less performant, more complex, more expensive, or less efficient transmissions than is desirable under the present invention.

### SUMMARY

The present disclosure provides a compact differential pulley transmission utilizing a single, closed, flexible, continuous element. This is made possible by clever pulley arrangements and flexible element routings that permit large mechanical advantages to be developed with approximately twice the effective actuator stiffness as prior approaches. This transmission is particularly relevant for applications involving linear actuation.

### BRIEF DESCRIPTION OF THE DRAWINGS

The disclosure will be more fully understood from the following detailed description, taken in conjunction with the accompanying figures, wherein like reference numerals refer to like elements, in which:

FIG. 1 is an isometric view of a differential pulley transmission system, which includes a twisted belt and cylindrical coupled pulleys, according to one embodiment.

FIG. 2 shows kinematic relationships between the belt and carriage of a differential pulley transmission to aide deriving the transmission ratio.

FIG. 3 is a side view of the differential pulley transmission system of FIG. 1 showing axial belt twist over straight segments.

FIG. 4 is an isometric view of a differential pulley transmission system, which includes an angled belt plane and conical coupled pulleys, according to another embodiment.

FIG. 5 is a simplified side view of the differential pulley transmission system of FIG. 4 showing key geometry of the system.

FIG. 6 is a simplified view of a toothed belt engaging a conical pulley showing groove affordances that permit the belt to cleanly engage the pulley.

FIG. 7 is an isometric view of a differential pulley transmission system, arranged such that principal elements have parallel axes via twisted belt segments and coupled conical pulleys, according to another embodiment.

FIG. 8 is a simplified side view of differential pulley transmission system of FIG. 7 showing key geometry.

FIG. 9 is an isometric view of an additive pulley transmission system wherein two different belt sections, traveling in opposite directions, engage the same side of the coupled pulleys, forming an additive transmission.

FIG. 10 shows kinematic relationships for the additive transmission to aide deriving the transmission ratio.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

As referenced herein, a “flexible continuous element” is an element of continuous construction, having no discrete or reversibly-separable sub-elements. “Flexible” refers to the ability of the element to bend about axes arbitrarily located and oriented, having in the ideal arbitrary curvature and segment length. Use of the term “cable” refers to any flexible continuous element designed to transmit power via tension while bending along arbitrary axes with limited axial twisting, such as steel wire cables, fibrous or braided rope, and elastomeric continua. The term “belt” as used herein refers generally to flexible continuous elements designed transmit power in tension while experiencing only planar bending and limited axial twisting, such as flat and grooved belts (“V-belts”), polymeric, steel, or other tapes, and elements with positive engagement features such as timing or synchronous belts. As distinguished from belts, chains generally do not tolerate axial twisting and are not composed of a flexible continua but rather discrete rigid bodies. The “engagement” between a belt or other flexible continuous element and a pulley refers to contact and lack of relative motion between the referenced elements as mediated by contact friction or the interference of specific engagement features like belt teeth and pulley grooves.

As used herein, the word “differential” of a differential pulley transmission refers to routings of the flexible continuous element whereby it engages the coupled pulleys on opposing sides of the coupled pulley rotation axis, such that the translation of the carriage and coupled pulleys is the difference of those engagements, as elaborated in FIG. 2. When those engagements occur on the same sides of the coupled pulleys, their addition describes the translation of the carriage and the transmission is called “additive.”

Three new approaches to realizing a differential pulley transmission in belt systems are shown. While discrete embodiments, they may be unified, and the core advance appreciated, by examining variations in certain key angles among the pulleys and belt routing plane(s) that distinguish the embodiments. The first embodiment uses cylindrical coupled pulleys and belt twisting to allow the same belt to engage both coupled pulleys. The second embodiment adopts conical coupled pulleys to maintain a single belt plane. The third combines the prior two embodiments to achieve parallel shafting of the torque source and coupled pulleys.

A first embodiment is premised on the observation that belts are generally capable of bending or twisting but may undergo only one form of deformation at a time. That is, belts may slowly twist over straight sections or they may bend around pulleys, but if these are simultaneous the belt will not follow the intended path. This first embodiment exploits twisting of a belt about its lengthwise direction to transition between multiple planes and thereby form a differential pulley transmission with a single closed belt.

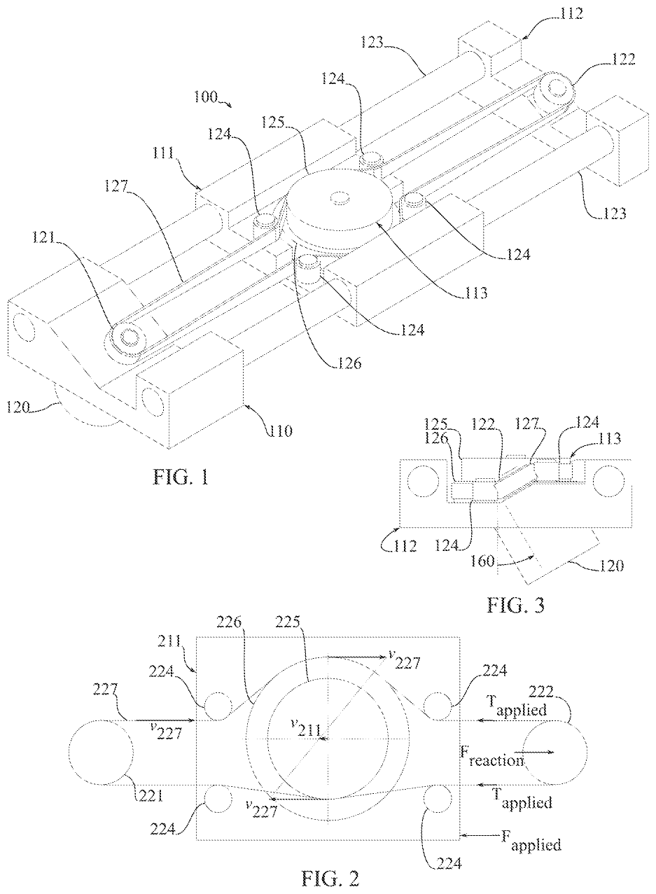

A twisted cylindrical differential transmission system 100 is shown in FIG. 1. Within the differential transmission system 100 are a drive subassembly 110, a carriage subassembly 111, and a return subassembly 112. The drive subassembly 110 hosts a torque source 120 on whose shaft is fixed a driving pulley 121. The torque source 120 may be regarded as an electric motor of the stepper, direct current, or alternating current designs, though the invention is equally realizable with other motor technologies, such as pneumatic or hydraulic motors. The return subassembly 112 hosts a rotatably fixed driven return pulley 122. Between the drive subassembly 110 and return subassembly 112 are one or more linear guide elements 123, shown as two rods, which are fixed to the drive subassembly 110 and/or return subassembly 112. Along the linear guide elements 123 rides the carriage subassembly 111; the carriage subassembly 111 is thus constrained by the linear guide elements 123 to move along a line between the drive subassembly 110 and return subassembly 112 according to the function of the linear elements 123. Rotatably fixed to the carriage subassembly 111 are four or more idle pulleys 124 and a coupled pulley subassembly 113. The coupled pulley subassembly 113 consists of a smaller diameter pulley 125 coupled to a larger diameter pulley 126 such that they share a central rotation axis. Idle pulleys 124 are positioned to route a closed belt 127 between the driving pulley 121 and return pulley 122 while engaging the smaller diameter pulley 125 and larger diameter pulley 126. When the closed belt 127 is made to circuit the twisted cylindrical differential transmission system 100 by the torque source 120, the differing diameters of the smaller diameter pulley 125 and larger diameter pulley 126 give rise to differing tensions in segments of the closed belt 127 which results in translation of the carriage 111 along the linear guide elements 123. It may be seen in FIG. 1 that the torque source 120, driving pulley 121, and driven return pulley 122 have parallel rotation axes, axes that are angled relative to the parallel rotation axes of the idle pulleys 124 and coupled pulley subassembly 113.

FIG. 2 summarizes the operation of differential pulley transmissions via the method of instantaneous centers. As drawn, a closed belt 227 has a translational velocity of v₂₂₇ while transiting between a driving pulley 221 and driven return pulley 222. A carriage 211 is free to translate horizontally on the page, subject to the force balance on a smaller diameter pulley 225 and a larger diameter pulley 226. Idle pulleys 224 direct closed belt 227 to engage the coupled pulleys. No-slip contact of closed belt 227 with the larger coupled pulley 226 imparts a rotational velocity to the coupled pulley of v₂₂₇*r₂₂₆, with r₂₂₆ being the radius of the larger diameter pulley 226, and likewise contact with the smaller coupled pulley 225 imparts a rotational velocity of v₂₂₇*r₂₂₅, where r₂₂₅ is the radius of the smaller diameter pulley 225. As these rotational velocities differ in magnitude, for the smaller diameter pulley 225 to remain coupled to the larger diameter pulley 226, carriage 211 must move with the direction and speed indicated by v₂₁₁, or the belt must stop moving, break, or slip on one of the pulleys. The velocity of carriage 211 may be determined by Equation 1.

$${v}_{211} = - {v}_{227} \frac{{r}_{226} - {r}_{225}}{{r}_{226} + {r}_{225}} \qquad Equation 1$$

The leading negative sign indicates the carriage moves oppositely to the belt segment engaged with the larger diameter pulley 226, as drawn. The transmission ratio may be explicitly calculated by Equation 2.

$$k = \frac{{r}_{226} - {r}_{225}}{{r}_{226} + {r}_{225}} \qquad Equation 2$$

Similarly, the position of the carriage in time, x₂₁₁(t), may be found from the coupled pulley radii along with the radius of a driving pulley 221 r₂₂₁ and the angular position of the motor shaft θ₂₂₁(t) according to Equation 3.

$${x}_{211} ( t ) = - \frac{{r}_{226} - {r}_{225}}{{r}_{226} + {r}_{225}} {r}_{221} {θ}_{221} ( t ) \qquad Equation 3$$

Changing the radii of the coupled pulleys, r₂₂₅ and r₂₂₆, changes the transmission ratio of the mechanism such that large reductions and very fine motion may be realized.

As the same closed belt 227 engages both the driving 221 and return 222 pulleys, loads applied to carriage 211 will be borne by both segments of the belt, depending on the direction of the load. FIG. 2 is illustrated with a force F_{applied} directed to the left; in the static case this applied force is divided between the two legs of the belt, T_{applied}, as it is transmitted to the return pulley 222 as F_{reaction}. Since all belts have an innate stiffness, this division of the applied load effectively doubles the apparent stiffness of the carriage versus typical mechanisms that load only a single leg of a closed belt. Of course, belt-pulley engagement determines the maximum load that may be borne, statically or dynamically, in the direction of travel.

Many implementations will utilize belts with discrete engagement features to provide positive engagement and thereby maintain registration; this raises additional considerations. First, the coupled pulley radii must be chosen to result in pulleys with an integer number of grooves about their circumference, 2πr/p=N, where N is the number of grooves, p the belt tooth pitch, and r is the pulley radius. While un-toothed differential pulley transmissions may achieve any ratio in the ideal, teeth or other features necessarily limit the achievable transmission ratios.

FIG. 3 shows a side view of the twisted cylindrical differential transmission system 100 from the perspective of the right end. Angle 160 is drawn to measure the axial twist of the closed belt 127 as it travels from the return pulley 122 to the larger diameter pulley 126. The same angle 160 may be found between the rotation axes of the return pulley 122 and the coupled pulley subassembly 113. With the coupling plane of the coupled pulley subassembly 113 as a horizontal datum and the axis of rotation of the coupled pulley subassembly 113 locating a vertical datum, the intersection of the horizontal datum and vertical datum defines a central axis of system 100. Coincident with the central axis of system 100 is an axis defined by the intersection of the midplane of the return pulley 122 and a plane perpendicular to the midplane located at return pulley 122's rotation axis. The return pulley 122 is inclined about this coincident central axis by angle 160. Though not visible in FIG. 3 but seen in FIG. 1, driving pulley 121 is similarly positioned and inclined.

The torque source 120, driving pulley 121, and return pulley 122 are thereby angled to position opposing segments of the closed belt 127 to engage either the smaller diameter pulley 125 or the larger diameter pulley 126. Angle 160 may be determined by trigonometry from the width of the closed belt 127, the diameter of the return pulley 122, and the desired clearance between the belt segments on coupled pulley subassembly 113. In many cases the diameter of the driving pulley 121 and the diameter of the return pulley 122 will equal, with both pulleys lying in the same plane. In other cases, when the diameter of the driving pulley 121 and the diameter of the return pulley 122 differ, they will inhabit similar but non-parallel planes. This non-symmetric case will also position idle pulleys 124 differently, so as to maintain pure axial twist about the segments of closed belt 127. The position of idle pulleys 124 in turn determines the length of contact of the two sections of the closed belt 127 with the smaller diameter pulley 125 and the larger diameter pulley 127. These contact arcs may be further modified, and equalized, by displacing rotation axis of the driving pulley 121 and return pulley 122 from the central axis.

Maintaining engagement between the belt and pulley surfaces is essential to realizing a differential pulley transmission, as belt slip can lead to undesirable carriage motion or lack of motion. Beyond typical considerations such as the belt tension and friction characteristics, the quality of the belt/pulley contact significantly depends on the angle of wrap on the pulley surfaces. The angle of wrap is the angle of the belt/pulley contact arc measured about the rotation axis. It can be seen in FIG. 1 and FIG. 2 that the angle of wrap is a function of the coupled pulley radii, the positioning of the carriage idlers, and the radius of the driving and return pulleys. Calculation of the angle of wrap, and hence the predicted minimum belt tension to avoid slip, is readily achieved through geometric analysis.

Implementations using flat or timing belts are most constrained by the belt's design for planar bending, where the belt's centerline lies in a single plane. Round belts or cables or other flexible continuous elements capable of multi-axis bending may, naturally, be employed in the present invention, enjoying fewer constraints though suffering their particular power transfer and efficiency limits. Flanges may be employed on all pulleys and particularly on the carriage-mounted idle pulleys 124 to encourage the belt to remain in the designed position.

Closed belt 127 is subject to strain from axial twisting over the free-space spans between, in FIG. 1, the driving pulley 121 and idle pulleys 124 and return pulley 122 and idle pulleys 124. As belts are designed to bear tensile loads evenly across constituent tensile members, the design consideration is to minimize the difference in strains across the belt width and to reduce the strain rate of change. For discussion, consider a typical closed, toothed timing belt consisting of circumferential tensile fibers encased in rubber with molded teeth on the inside of the belt. While tensioned in a system like that of the twisted cylindrical differential transmission system 100 in FIG. 1, axial twisting between 121 and 124 causes greater strain in the peripheral fibers than those nearer the centerline. Failure of the belt will occur if this strain exceeds the design limit of the tensile fiber members particular to that belt, either due to instantaneous or cyclical loading. Thus, avoiding significant belt twist over a short distance may inform the closest approach of the carriage 111 to the driving pulley 121 or return pulley 122. The belt specification may also state a maximal strain rate, which may determine the maximal belt speed.

This first embodiment may be summarized by its particular choices for the degree of axial twist along straight belt sections, the angle(s) describing the inclination of the driving and return pulleys, and the 0° face angle of the coupled cylindrical pulleys.

A second embodiment exploits a non-cylindrical pulley to permit a closed belt to move in a single plane without axial twist. An angled conical differential transmission system 400 is shown in FIG. 4. It is composed of a drive subassembly 410, a carriage subassembly 411, a return subassembly 412, and one or more linear guide elements 423 fixed to the drive subassembly 410 and/or the return subassembly 412. The carriage subassembly 411 rides on the linear guide elements 423 while traveling between the drive subassembly 410 and return subassembly 412. The drive subassembly 410 hosts a torque source 420 on whose shaft is fixed a drive pulley 421. The torque source 420 may again be a rotating electric motor or it may employ some other principle to transform stored energy into shaft torque. The return subassembly 412 hosts a rotatably-mounted driven return pulley 422. The carriage subassembly 411 hosts four or more freely-rotating idle pulleys 424 as well as a coupled pulley subassembly 413. Coupled pulley subassembly 413 is rotatably mounted to the carriage subassembly 411 and consists of a smaller conical pulley 425 and a larger conical pulley 426 coaxial with it, coupled between their larger-diameter faces. Idle pulleys 424 are positioned to route a closed belt 427 between the driving pulley 421 and return pulley 422 while engaging the smaller conical pulley 424 and larger conical pulley 425. Driving pulley 421, return pulley 422, and idle pulleys 424 have parallel rotation axes which differ from the rotation axis of the coupled pulley subassembly 413.

When the closed belt 427 is made to circuit the angled conical differential transmission system 400 by the torque source 420, the differing effective diameters of the smaller conical pulley 425 and larger conical pulley 426 give rise to differing tensions in segments of the closed belt 427 which results in translation of the carriage 411 along the linear guide elements 423. The motion of these elements can be modeled by FIG. 2 and Equations 1-3.

When discussing conical pulleys, it is convenient to refer to their radius, by which is meant the largest radius at which the centerline of the engaged belt exhibits no slip. This effective radius is bounded between the smaller and larger or base radii of the pulley's radial faces. The conical face which engages the belt can be described by the radii and a face angle, which for a conical pulley is identical to the cone angle and may be measured from the cone axis to any surface ray.

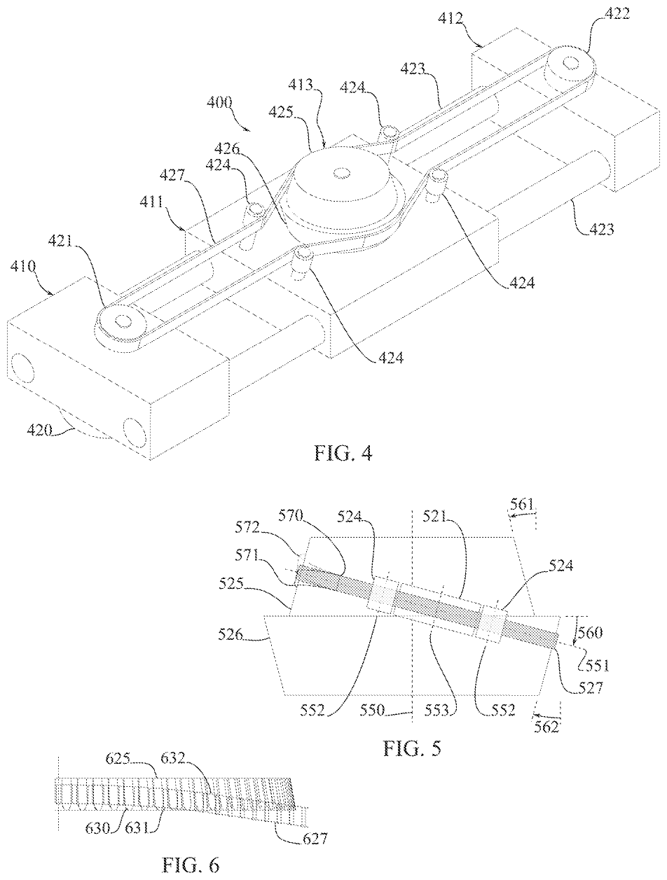

FIG. 5 shows a simplified side view of the angled conical differential transmission system 400 of FIG. 4. A smaller conical pulley 525 and a larger conical pulley 526 are joined along a horizontal coupling plane, with their cones pointing opposing directions. The conical pulleys rotate about the vertical dashed line 550. A closed belt 527 is shown engaging with the smaller conical pulley 525, the larger conical pulley 526, a drive pulley 521, and idle pulleys 524, with the belt and pulleys drawn partially transparently to show the complete belt path. Closed belt 527's principal movement plane is indicated by the dashed line 551. Idle pulleys rotate about axes indicated dashed lines 552 while drive pulley 521 rotates about dashed line 553. In order for the length of closed belt 527 (or closed belt 427) to remain constant, the belt sections between drive pulley 521 and translating idle pulleys 524, as well as those on the other side which interface with return pulley 422, must be straight. This implies that the distance between the parallel rotation axes 552 and 553 is the sum of the radius of the driving pulley 521, the thickness of belt 527, and the radius of the idle pulley 524.

Defining a first axis into the page at the intersection of the belt plane 551 and the axis 553, and a second axis into the page at the intersection of the conical pulley coupling plane and rotation axis 550 allows defining an offset between these two axes. Angle 560 is defined between the belt plane 551 and the conical pulley coupling plane, while angle 561 is the cone angle of the smaller conical pulley 525, and angle 562 that of the larger conical pulley 526. The position and angle of wrap of the belt on the conical pulley surfaces are determined by the axis offset, angles 560, 561, and 562, the base radii of the conical pulleys, and the positions and radii of the idle and drive pulleys. As before, the horizontal and vertical axis offsets may be adjusted to affect or equalize the angle of wrap over each conical pulley and thereby the belt engagement on each. Belt angle 560 influences every design decision and should be chosen early in the implementation or as part of a multi-parameter design optimization. Generally, smaller angles are preferred as these require less belt conformation to the conical pulley surfaces, though this suggests larger coupled pulley radii to ensure adequate belt contact with the conical surface. Figures like FIG. 5 make this design trade clear.

FIG. 5 additionally illustrates the competing tendencies of a belt on a conical surface to climb and descend. The conical surface of the smaller coupled pulley 525 is rotating about its axis 550, such that any point on the surface will trace a horizontal line on the page. 570 denotes the line of first contact of the approaching belt 527. If belt 527 maintained perfect contact with the surface, situation 571, the belt would move exactly with the surface, strictly horizontally and in complete contact with the pulley surface until reaching the line of departure on the far side. As drawn, this situation entails out-of-plane bending of the belt, loading the upper fibers of the belt more than the lower.

In the less-idealized condition 572, surface friction varies over the contact arc. Recalling that the intersection of the angled belt plane and conical pulley surface is an ellipse, the belt's upper edge traces a shorter elliptical arc than the lower edge. Were the belt's tensile members independent, the fiber on the lower, longer edge would bear the majority of the belt tension and the upper fiber little. But as the tensile members are joined across the width of the belt, the upper edge will be unable to conform to the surface along the smaller arc, potentially held away from the surface by the transverse linking. In particular cases it may lift off the surface, decreasing the contact area and increasing the likelihood that the belt may slide farther upward, towards smaller cone radii to minimize the length of the lower contact arc. This may manifest as a belt curved upward from the nominal belt plane, condition 572.

Both conditions 571 and 572 are highly particular to a given application and design, and they may alternate in relative importance as the system speed and loading change. It is for these reasons that implementors may choose to employ slightly differing angles between the belt plane 560 and conical surface angles 561 and 562, thereby modifying belt loading and tracking. Relatedly, while described as a conical surface, certain applications, especially those involving flat, untoothed belts, should consider non-conical surfaces, as slight deviations from strict linearity may aide belt tracking under variable loads and speeds.

While the timing belt teeth are parallel across the width of the belt, grooves on a conical pulley are not parallel but rays of a cone. Since maintaining a constant groove profile over the width of the pulley is not geometrically possible, affordances can be designed into the pulley grooves to ensure proper meshing over the arc of contact. FIG. 6 shows one approach to afford the belt teeth freedom to conform to the pulley while remaining positively engaged. It depicts an edge-view of a conical pulley 625 and a timing belt 627 as might be seen in the angled conical differential transmission system 400 of FIG. 4. Timing belt 627 is drawn transparently with tangent edges shown, to show the engagement of the belt teeth and pulley grooves. For simplicity of depiction, the grooves of the conical pulley 625 are drawn as rectangular along rays of the cone. Relative to a standard cylindrical timing pulley, pulley grooves 630 are widened and given a fan to permit greater tooth 631 clearance as the belt approaches and departs the pulley surface. Contact begins near 632 from an unloaded, geometric perspective, at which point the tooth is significantly within the pulley groove. The belt path and therefore motion of the tooth within the groove is idealized in the same manner as in FIG. 5 and may again tend to follow 571 or 572 depending on the belt loading, speed, and transmission design.

What should be clear from FIG. 6 is that situations 571 or 572 will influence the engagement of the teeth with the grooves and thereby determine what fraction of the transmitted power is transferred by tooth/groove interference and by friction over the angle of wrap. The design of the pulley grooves is therefore a key design and manufacturing consideration, one that should be included in the overall system trade and not considered subsequently in isolation. Keeping the belt plane and cone angles small generally reduces the degree of compromise in the groove profile and may allow power transfer nearer to the belt design limit. Of course, belt choice will determine the design of the engagement features. And as discussed above, flanges may be employed on all pulleys to encourage proper belt tracking.

Relative to the twisted cylindrical differential transmission system 100, this second embodiment continues to incline the driving and return pulleys with respect to the coupled pulley's coupling plane, but instead of twisting belt sections to engage cylindrical coupled pulleys, it modifies the coupled pulley face angle to meet the inclined belt.

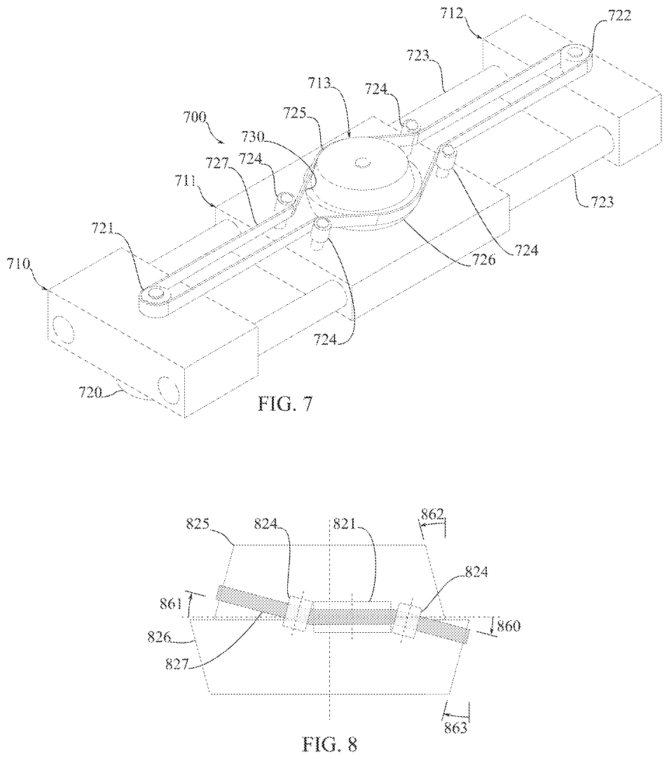

FIG. 7 shows a third embodiment which combines elements of the preceding embodiments to form a twisted conical differential transmission system 700. A carriage subassembly 711 moves between a driving subassembly 710 and a driven return subassembly 712 along one or more linear guide elements 723 fixed to the drive subassembly 710 and/or return subassembly 712. The drive subassembly 710 again hosts a torque source 720 which may be an electric or other motor onto whose shaft is fixed a driving pulley 721. The return subassembly 712 hosts a rotatably fixed return pulley 722. The translating carriage subassembly 711 hosts four or more rotatably fixed idle pulleys 724 and a coupled pulley subassembly 713. The coupled pulley subassembly 713 consists of a smaller conical pulley 725 and a larger conical pulley 726 concentrically joined at their larger-radius faces. A closed belt 727 made to circuit the various pulleys by the torque source 720 and guided to engage the coupled pulley assembly by idler pulleys 724. Similar to the first embodiment, the idler pulleys 724 are positioned to effect pure axial twist between the driving pulley 721 and the first set of idle pulleys 724, and between the return pulley 722 and the second set of idle pulleys 724, while maintaining a constant belt length.

FIG. 8 presents the same, simplified geometric side view of FIG. 7 as FIG. 5 does of FIG. 4. A smaller conical pulley 825 is coupled to a larger conical pulley 826, with their coupling plane defining a horizontal datum and their rotation axis a vertical datum. A driving pulley 821 rotates about an axis parallel to that of the coupled conical pulleys, though it may be offset from the horizontal and vertical datums. Idle pulleys 824 are positioned induce pure axial twist in sections of closed belt 827 spanning the driving pulley 821 and idle pulleys 824, while directing subsequent belt sections onto the conical surfaces of the smaller conical pulley 825 and the larger conical pulley 826. Angle 860 describes the angle of the belt section engaging with the larger conical pulley 826, and angle 861 that engaging the smaller conical pulley 826. Angle 862 measures the cone angle of the smaller conical pulley 825 and angle 863 that of the larger conical pulley 826. As before, these angles may equal or be individually modified to encourage belt tracking. Likewise, the surfaces of coupled pulleys 825 and 826 are not necessarily conical but may be customized to the needs of each implementation.

As this embodiment includes both belt twisting and conical coupled pulleys, the preceding comments on limiting the belt twist rate, on the angle of wrap being a function of the various offsets, angles, and radii, on the suitability of pulley flanges, on the preference for smaller cone angles, on the tendency for a belt to ascend or descend the conical surface, on the non-parallelity of pulley grooves and need for groove affordances apply equally here. FIG. 2 and Equations 1-3 may again be used to calculate the transmission ratio.

The twisted conical differential transmission system 700 of FIG. 7 and FIG. 8 requires additional analysis to ensure the belt contacts only the intended surfaces. FIG. 7 highlights the typically-limiting case where the belt approaching the smaller coupled pulley 725 may, through improper positioning of carriage idler pulleys 724 and choice of the driver 721 and return 722 radii, contact the edge of the larger coupled pulley 726 near 730 and likewise departing 726. That is, the twisted conical embodiment requires clearance between the carriage idle pulleys 724 and the coupled pulleys in which the belt travels away from the coupling plane and potential interferences.

Relative to the preceding embodiments, this twisted conical differential transmission system 700 is distinguished by the parallel axes of the driving, coupled, and return pulleys which in turn necessitate both axial belt twisting, as seen in the twisted cylindrical differential transmission system 100, and angled coupled pulley faces, as seen in the angled conical differential transmission system 400.

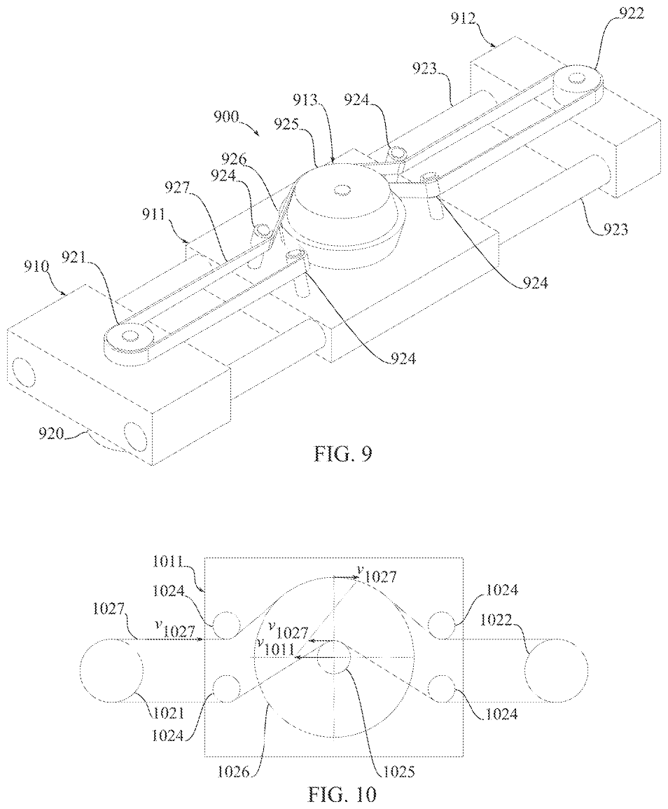

While many applications seek finer motion and greater actuation force than directly provided by their torque source, other applications have lightweight loads and desire fast movement. FIG. 9 shows a fourth embodiment with an alternative belt routing, where belt motions are additive rather than differential, by which the carriage can be made to move faster than the belt.

A twisted conical additive transmission system 900 is shown in FIG. 9, having a driving subassembly 910, carriage subassembly 911, and driven return subassembly 912. The driving subassembly 910 hosts a torque source 920, which is commonly an electric motor but may employ some other power source, on whose shaft is fixed a driving pulley 921. The return subassembly 912 hosts a rotatably fixed return pulley 922. One or more linear guide elements 923 are fixed to the driving subassembly 910 and/or to the return subassembly 912 and permit the carriage subassembly 911 to translate between the driving subassembly 910 and return subassembly 912 according to the motion and tensile forces in a closed belt 927. The carriage subassembly hosts four or more idle pulleys 924 alongside a coupled pulley subassembly 913, each rotatably fixed to the translating carriage. The coupled pulley subassembly 913 consists of a smaller conical pulley 925 joined to a larger conical pulley 926 along their larger faces.

Idle pulleys 924 are positioned to direct a first segment of the closed belt 927 onto the conical surface of the smaller conical pulley 925, and to direct a second segment of the closed belt 927 onto the conical surface of the larger conical pulley 926, both conical pulleys engaged by the belt on the same side with respect to the coupled pulley subassembly's axis of rotation. When 927 does not slip on any of the pulleys, applied torques are transmitted to the carriage 911 as forces, causing it to move along the linear guide elements 923. FIG. 9 is drawn with both sides of the belt engaged, as can be realized with two-sided timing belts, flat belts, or round or other flexible continuous elements of uniform cross-section. Engaging the same side of the coupled pulley subassembly 913 yields a transmission ratio greater than one, causing the carriage subassembly 911 to move faster than the closed belt 927.

Similar to FIG. 2, FIG. 10 uses the method of instantaneous centers to derive the kinematic relations of additive pulley transmissions like those of FIG. 9. As drawn, a torque source induces a translational velocity of v₁₀₂₇ in a closed belt 1027 by a driving pulley 1021. A carriage 1011 is free to translate horizontally on the page, according to the force balance on a smaller diameter pulley 1025 and a larger diameter pulley 1026. No-slip contact of closed belt 1027 with the larger coupled pulley 1026 imparts a rotational velocity to the coupled pulley of v₁₀₂₇*r₁₀₂₆, with r₁₀₂₆ being the radius of the larger diameter pulley 1026, and likewise contact with the smaller coupled pulley 1025 imparts a rotational velocity of v₁₀₂₇*r₁₀₂₅, where r₁₀₂₅ is the radius of the smaller diameter pulley 1025. As these rotational velocities differ, for the smaller diameter pulley 1025 to remain coupled to the larger diameter pulley 1026, carriage 1011 must move with the direction and speed indicated by v₁₀₁₁. The velocity of carriage 1011 may be determined by Equation 4.

$${v}_{1011} = - {v}_{1027} \frac{{r}_{1026} + {r}_{1025}}{{r}_{1026} - {r}_{1025}} \qquad Equation 4$$

The transmission ratio may be explicitly calculated by Equation 5.

$$k = \frac{{r}_{1026} + {r}_{1025}}{{r}_{1026} - {r}_{1025}} \qquad Equation 5$$

Note that Equation 5 is the inverse of Equation 2, with the smallest differences in radii leading to the greatest multiplier on the belt speed. The position of the carriage in time, x₁₀₁₁₍t), may be found from the coupled pulley radii along with the radius of the driving pulley 1021 r₁₀₂₁ and the angular position of the motor shaft θ₁₀₂₁(t) according to Equation 6.

$${x}_{1011} ( t ) = - \frac{{r}_{1026} + {r}_{1025}}{{r}_{1026} - {r}_{1025}} {r}_{1021} {θ}_{1021} ( t ) \qquad Equation 6$$

Although the twisted conical additive transmission system 900 was drawn similarly to the twisted conical differential transmission system 700 of FIG. 7, it may be correspondingly realized in the forms of the angled differential transmission system 400 of FIG. 4 or the twisted cylindrical differential transmission system 100 of FIG. 1. That is, while differing topologically in the belt routing from the prior three embodiments, this additive embodiment is enabled by the same angling of pulleys, twisting of belt sections, and conical coupled pulleys exploited the prior embodiments. The belts in FIG. 9 and FIG. 10 are depicted engaging the coupled pulleys on both inside and outside surfaces, as may be achieved through flexible elements without positive engagement or with two-sided timing belts. Alternately, it may be seen that the twisted cylindrical differential transmission system 100 may employ a single-sided timing belt if the belt twist angle 160 is 90° and idler pulleys 124 nearly coaxial in FIG. 3. As before, the success of this highly-twisted approach depends heavily on belt choice and application loading.

Considering then the first three embodiments, the twisted conical differential transmission system 700 of FIG. 7 has the most constrained design space, twisting the belt and engaging conical pulleys in order to locate the torque source, differential, and return on parallel planes. This parallel alignment enables designs very similar those found in the market, potentially allowing interchangeability with existing solutions. This approach may be favored for manufacturing reasons, as only idle pulleys 724 are angled.

The angled conical differential transmission system 400 of FIG. 4 demands the least belt performance, whose planar movement is complicated only by the interface with the conical pulleys. This may be lessened by carefully considering the belt plane angle and preferring to transmit power by contact friction over large wrap angles. Producing a conical pulley is not trivial, especially in applications with small tooth pitch or high speed, but their features are not too different from those found in bevel gearing.

Finally, the twisted cylindrical differential transmission system 100 of FIG. 1 is the simplest to design and analyze. Robust exploration of the belt twist angle may permit the drive and return pulleys to be perpendicular to the coupled cylindrical pulleys with 900 of belt twist, which in turn may again enable interchangeability with segments of the existing market. Clearly, managing belt loading and life is essential to any implementation.

Across the embodiments, flanges on the idle, driving, and return pulleys are recommended to ensure the tracking stability of the flexible continuous element. Tensioning of the flexible continuous element may be performed by any suitable means according to the needs of a particular implementation. As the embodiments are designed from the notional perspective of arbitrarily positioning some load, the flexible continuous element is tensioned during assembly and not by any dedicated subassembly. Of course, implementors may employ explicit tensioning according to the needs of their application.

Additional or fewer idle pulleys may be incorporated according to the needs of a particular application; the use of four idle pulleys across the embodiments is merely to indicate a means of directing the belt to engage the coupled pulleys. Some applications may even omit explicitly-rotating pulleys entirely, instead relying on simple static guides to direct the belt as required. In the present embodiments, especially the twisted cylindrical differential transmission system 100, idle pulleys are located on the translating carriage with the coupled pulleys; they may instead be located on the driving pulley and driven return pulley subassemblies, accomplishing the necessary twisting of the flexible continuous element over short, constant-length spans rather than the variable-length approach of the embodiments.

Though the embodiments are illustrated with linear rods for guidance of the carriage, this invention is not particular to the method of guidance, functioning in principle even if the carriage is guided only by the tension of the flexible continuous element.

Reference to a “carriage” and “carriage subassembly” are made only to use terms familiar to practitioners, wherein the carriage locates sub-elements on a translating element, transmits transmission reaction forces to any linear guide elements, and provides features to interface with external loads. Implementations omitting linear guidance may similarly neglect a discrete carriage element or subassembly, perhaps attaching loads directly to the coupled pulleys.

The presented embodiments locate the torque source at one end of the linear guide, fixed to other non-translating elements, though the torque source may equivalently be located on the translating carriage driving the coupled pulleys, or at the opposite end driving what has been referred to as the driven return pulley. That is, the “driving” and “return” labels are merely descriptive, resulting from the location of the torque source.

One skilled in the art may implement this invention in a variety of ways with myriad different elements and for numerous applications; these choices will determine the exact nature of an individual embodiment and may result in systems that appear markedly different from the embodiments while also exploiting the novel concepts of this invention.

As utilized herein with respect to numerical ranges, the terms “approximately,” “about,” “substantially,” and similar terms generally mean+/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling is not restricted to any particular phenomena and may be mechanical, electrical, fluidic, chemical, or any other means capable of relating the reference elements.

References herein to the positions of elements (e.g., “top,” “bottom,” “above,” “below”, “left”, “right”, “horizontal”, “vertical”) are merely used to describe the orientation of various elements in the FIGURES. It should be noted that the orientation of various elements may differ according to other exemplary embodiments, and that such variations are intended to be encompassed by the present disclosure. Use of geometric terms like “axis,” “plane,” “intersection,” and “radius,” and related measures, are merely descriptive, used only to communicate potential relationships between various elements in and between embodiments.

It is important to note that any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A transmission converting rotary motion to translatory motion comprising:
a pair of pulleys having differing base radii and predetermined face angles coaxially coupled about some plane,
a driving pulley,
a driven return pulley,
a predetermined number of idle pulleys, and
a single, inextensible, closed, flexible continuous element,
wherein said flexible continuous element is conducted to engage with each of said coupled pulleys, said driving pulley, and said return pulley by said idle pulleys,
with said driving pulley, driven return pulley, and said idler pulleys rotatably fixed at predetermined angles with respect to the coupling plane of said coupled pulleys,
having said driving pulley and driven return pulley bilaterally disposed, between which said coupled pulleys are free to translate,
such that movement of said flexible continuous element by the rotation of said driving pulley induces differing rotations in said coupled pulleys which are resolved by translation of said coupled pulleys with respect to said driving and return pulleys.

2. The transmission of claim 1, wherein
a first engagement of said flexible continuous element with the first of said coupled pulleys induces rotation of said coupled pulleys,
and a second engagement of said flexible continuous element with the second of said coupled pulleys induces rotation in the same direction but with differing magnitude than said first engagement,
such that said coupled pulleys and any elements rotatably or fixedly attached to these experience translation at a rate less than that of said flexible continuous element due to said differing radii,
forming a differential transmission.

3. The transmission of claim 1, wherein
a first engagement of said flexible continuous element with the first of said coupled pulleys induces rotation of said coupled pulleys,
and a second engagement of said flexible continuous element with the second of said coupled pulleys induces rotation in the opposite direction and with differing magnitude than said first engagement,
such that said coupled pulleys and any elements rotatably or fixedly attached to these experience translation at a greater rate than that of said flexible continuous element due to said differing radii,
forming an additive transmission.

4. The transmission of claim 1, wherein
said coupled pulleys have cylindrical faces of differing radii
with a first pair of said idle pulleys positioned to conduct said continuous element to engage said first coupled pulley,
and a second pair positioned similarly for said second coupled pulley,
with the midplanes of said driving and return pulleys inclined predetermined angles relative to the coupling plane of said coupled pulleys, the mid- and coupling planes having an axis of intersection parallel to that of the direction of translation,
such that predetermined segments of said continuous element are twisted axially.

5. The transmission of claim 1, wherein
said coupled pulleys have conical outer faces of a predetermined face angle and differing base radii,
with a first pair of said idle pulleys positioned to conduct said continuous element to engage said first coupled pulley,
and a second pair of said idle pulleys positioned to conduct said continuous element to engage said second coupled pulley,
with the common midplane of said driving and return pulleys inclined a predetermined angle relative to the coupling plane of said coupled pulleys, the midplane and coupling plane having an axis of intersection parallel to that of the direction of translation,
such that said continuous element moves in a single plane while engaging said pulleys.

6. The transmission of claim 1, wherein
said coupled pulleys have conical outer faces of a predetermined face angle and differing base radii,
with a first pair of said idle pulleys positioned to conduct said continuous element to engage said first coupled pulley,
and a second pair of said idle pulleys positioned to conduct said continuous element to engage said second coupled pulley,
with the common midplane of said driving and return pulleys lying parallel to the coupling plane of said coupled pulleys,
with said idle pulleys each positioned and oriented to direct segments of said continuous element between said driving and return pulleys to engage said coupled pulleys,
such that predetermined segments of said continuous element are twisted axially while moving between pulleys.

7. The transmission of claim 1, wherein said conical coupled pulleys incorporate positive engagement features adapted to afford the corresponding engagement features of said continuous element clearance to engage and disengage said engagement features on said coupled pulleys.

8. The transmission of claim 1, wherein said continuous element is designed to transmit power by means of tension such as a flat, timing, synchronous, or other belt, or a cable.

9. The transmission of claim 1, wherein said pulleys include flanges or other means to restrict said continuous element to its predetermined path.
